(19) United States
(12) Patent Application Publication
(10) Pub. No.: US 2013/0208305 A1
(43) Pub. Date: Aug. 15, 2013

(54) SYSTEM AND METHOD FOR CONFIGURING THE LAYOUT AND MANUFACTURE OF PERSONALIZED BRACELETS

(71) Applicant: Russell Andrew Martin Epstein, Mamaroneck, NY (US)

(72) Inventor: Russell Andrew Martin Epstein, Mamaroneck, NY (US)

(73) Assignee: Social Produx, LLC, Port Chester, NY (US)

(21) Appl. No.: 13/397,584

(22) Filed: Feb. 15, 2012

(51) Int. Cl. G06K 15/02

(52) U.S. Cl. 358/1.15

(57) ABSTRACT

Systems and methods are provided for customization of a printed bracelet. According to a one aspect, a configuration tool is provided at a user interface, and the configuration tool is populated with one or more items. A custom bracelet design is received through the configuration tool, the custom bracelet design including an arrangement of one or more selections of at the items. The custom bracelet design is then outputted in furtherance of a printing of the printed bracelet.

### TECHNICAL FIELD OF THE INVENTION

This patent application relates generally to the field of custom design and, in particular, to systems and methods for dynamic customization of printed bracelets.

### BACKGROUND OF THE INVENTION

With the advent of social networking and digital photography, many users have access to a large number of digital media items, such as digital photographs. Such media items are generally only available for users to view and/or share when accessed through a computing device such as a computer or smartphone. It would thus be desirable for a user to be able to display and/or share such media in other settings and contexts, without dependence upon a computing device.

It is with respect to these and other considerations that the disclosure made herein is presented.

### SUMMARY OF THE INVENTION

Technologies are presented herein in support of a system and method for dynamic customization of a printed bracelet. According to a first aspect, a method for dynamic customization of a printed bracelet using a computing device is provided. The method includes providing a configuration tool at a user interface, populating the configuration tool with one or more media items, and processing, with a processor executing code, at least one of (i) the one or more media items and (ii) a first source from which the media items are obtained, in order to identify one or more user characteristics. The method further includes: based on the one or more user characteristics, further populating the configuration tool with one or more complementary items, the one or more complementary items originating from at least a second source, receiving, through the configuration tool, a custom bracelet design, the custom bracelet design including an arrangement of one or more selections of at least one of the one or more media items and the one or more complementary items, and outputting the custom bracelet design in furtherance of a printing of the printed bracelet

According to another aspect, a method for dynamic customization of a printed bracelet using a computing device is provided. The method includes providing a configuration tool at a user interface, populating the configuration tool with one or more complementary items, receiving, through the configuration tool, a custom bracelet design, the custom bracelet design including an arrangement of one or more selections of at least one of the one or more complementary items, and outputting the custom bracelet design in furtherance of a printing of the printed bracelet.

According to yet another aspect, a system is provided. The system includes a computing device and a printing device in communication with the computing device. The computing device includes one or more processors configured to interact with a computer-readable medium in order to perform operations including: providing a configuration tool at a user interface, populating the configuration tool with one or more media items, the one or more media items being obtained from a first source via a permission from a user, and processing at least one of (i) the one or more media items and (ii) the first source in order to identify one or more user characteristics. The one or more processors are further configured to interact with a computer-readable medium in order to perform operations including: based on the one or more user characteristics, further populating the configuration tool with one or more complementary items, the one or more complementary items originating from at least a second source, receiving, through the configuration tool, a custom bracelet design, the custom bracelet design including an arrangement of one or more selections of at least one of the one or more media items and the one or more complementary items, capturing an address associated with the printed bracelet, and based on the a custom bracelet design, activating the printing device to print the printed bracelet and the address on a perforated card, the perforated card being constructed (i) as a mailer and (ii) for assembly as the printed bracelet.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a high-level diagram illustrating an exemplary configuration of a custom design system;

FIG. 2 is a flow diagram showing a routine that illustrates a broad aspect of a method for recognizing one or more characters within a distorted image in accordance with at least one embodiment disclosed herein;

FIG. 3 depicts an exemplary screenshot of a configuration tool in accordance with at least one embodiment disclosed herein;

FIG. 4 depicts an exemplary design template in accordance with at least one embodiment disclosed herein; and

FIG. 5 depicts an exemplary perforated card in accordance with at least one embodiment disclosed herein.

### DETAILED DESCRIPTION OF CERTAIN EMBODIMENTS OF THE INVENTION

By way of overview and introduction, various systems and methods are described that enable dynamic customization of a printed bracelet. It can be appreciated that many individuals, and particularly those that utilize social networking websites, maintain significant collections of digital images, such as personal photos. While such images can be easily shared with other users when such users have access to an Internet-connected computing device such as a computer or smartphone, in situations where such devices are inaccessible (or no Internet connection is present), such images cannot be effectively shared with others. Moreover, it can be appreciated that many users desire to share such images through wearable printed accessories, such as bracelets.

In an effort to allow users to create such customized printed bracelets, the systems and methods described herein enable a series of operations whereby a configuration tool can be provided at a user interface (such as a web browser). The configuration tool can enable the user to populate the tool with various media or images from various sources, such as local or remote computing devices, and/or social networking (e.g., Facebook) and image repository (e.g., Flickr) sites. These items, and/or related information (such as information obtained from a social networking profile) can be processed in order to identify various user characteristics. These characteristics can then be utilized to further populate the configuration tool with additional items and/or images that can further complement the design of the printed bracelet that is to be generated. Through the configuration tool, a custom bracelet design, incorporating various of the items and images that were previously populated into the configuration tool, can be received. Then, the custom design can be subsequently rendered and printed on a perforated card which can also serve as a mailer.

The following detailed description is directed to systems and methods for dynamically customizing a printed bracelet. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

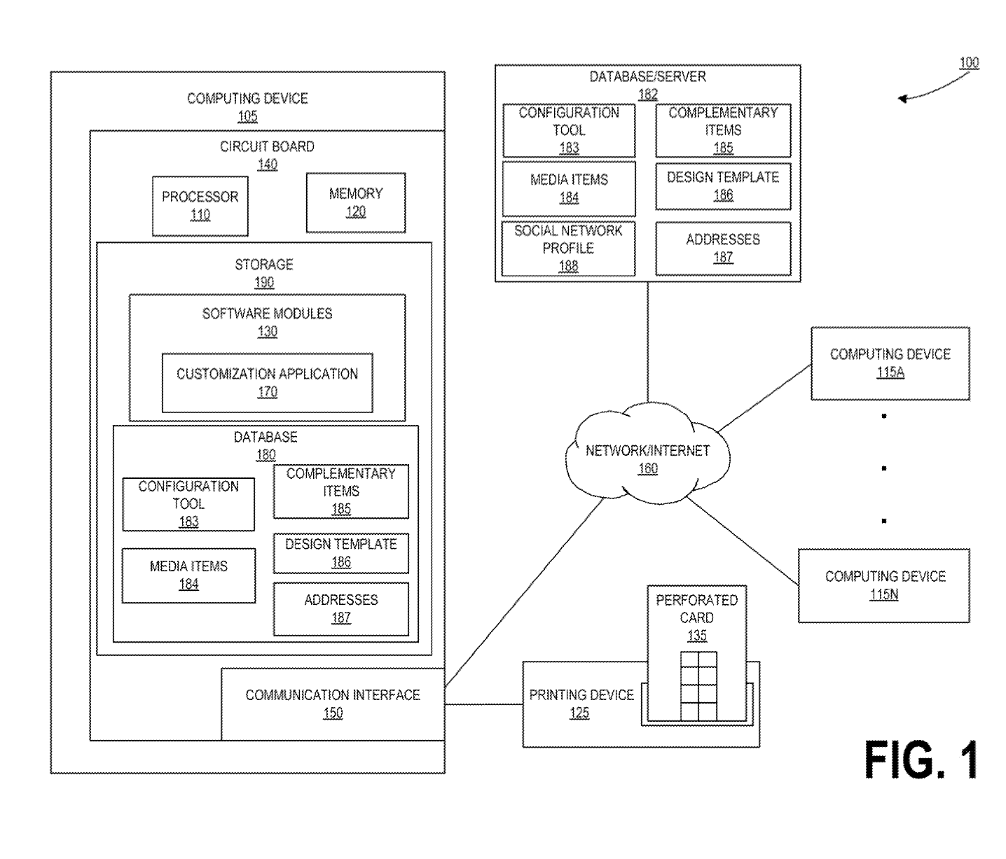

An exemplary computer system is shown as a block diagram in FIG. 1 which is a high-level diagram illustrating an exemplary configuration of a custom design system 100. In one arrangement, computing device 105 can be a personal computer or server. In other implementations, computing device 105 can be a tablet computer, a laptop computer, or a mobile device/smartphone, though it should be understood that computing device 105 of custom design system 100 can be practically any computing device and/or data processing apparatus capable of embodying the systems and/or methods described herein.

Computing device 105 of custom design system 100 includes a circuit board 140, such as a motherboard, which is operatively connected to various hardware and software components that serve to enable operation of the custom design system 100. The circuit board 140 is operatively connected to a processor 110 and a memory 120. Processor 110 serves to execute instructions for software that can be loaded into memory 120. Processor 110 can be a number of processors, a multi-processor core, or some other type of processor, depending on the particular implementation. Further, processor 110 can be implemented using a number of heterogeneous processor systems in which a main processor is present with secondary processors on a single chip. As another illustrative example, processor 110 can be a symmetric multi-processor system containing multiple processors of the same type.

Preferably, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 105, partly on computing device 105, as a stand-alone software package, partly on computing device 105 and partly on a remote computer/device, or entirely on the remote computer/device or server. In the latter scenario, the remote computer can be connected to computing device 105 through any type of network, including a local area network (LAN) or a wide area network (WAN), or the connection can be made to an external computer (for example, through the Internet 160 using an Internet Service Provider).

One or more software modules 130, including program code/instructions, are located in a functional form on one or more computer readable storage devices (such as memory 120 and/or storage 190) that can be selectively removable. The software modules 130 can be loaded onto or transferred to computing device 105 for execution by processor 110. It can also be said that the program code of software modules 130 and one or more computer readable storage devices (such as memory 120 and/or storage 190) form a computer program product that can be manufactured and/or distributed in accordance with the present invention, as is known to those of ordinary skill in the art.

It should be understood that in some illustrative embodiments, one or more of software modules 130 can be downloaded over a network to storage 190 from another device or system via communication interface 150 for use within custom design system 100. For instance, program code stored in a computer readable storage device in a server can be downloaded over a network from the server to custom design system 100.

Preferably, included among the software modules 130 is a customization application 170 that is executed by processor 110. During execution of the software modules 130, and specifically the customization application 170, the processor 110 configures the circuit board 140 to perform various operations relating to bracelet design customization with computing device 105, as will be described in greater detail below. It should be understood that while software modules 130 and/or customization application 170 can be embodied in any number of computer executable formats, in certain implementations software modules 130 and/or customization application 170 comprise one or more applications that are configured to be executed at computing device 105 in conjunction with one or more applications or ‘apps’ executing at remote devices, such as computing device(s) 115A-N (collectively computing devices 115) and/or one or more viewers such as internet browsers and/or proprietary applications. Furthermore, in certain implementations, software modules 130 and/or customization application 170 can be configured to execute at the request or selection of a user of one of computing devices 115 (or any other such user having the ability to execute a program in relation to computing device 105, such as a network administrator), while in other implementations computing device 105 can be configured to automatically execute software modules 130 and/or customization application 170, without requiring an affirmative request to execute. It should also be noted that while FIG. 1 depicts memory 120 oriented on circuit board 140, in an alternate arrangement, memory 120 can be operatively connected to the circuit board 140. In addition, it should be noted that other information and/or data relevant to the operation of the present systems and methods (such as databases 180 and/or 182) can also be stored on storage 190, as will be discussed in greater detail below.

A communication interface 150 is also operatively connected to circuit board 140. Communication interface 150 can be any interface that enables communication between the computing device 105 and external devices, machines and/or elements. Preferably, communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 105 to other computing devices and/or communication networks such as the Internet. Such connections can include a wired connection or a wireless connection (e.g. using the 802.11 standard) though it should be understood that communication interface 150 can be practically any interface that enables communication to/from the circuit board 140.

At various points during the operation of custom design system 100, computing device 105 can communicate with one or more computing devices 115A-N (collectively computing devices 115). The computing devices 115 transmit and/or receive data to/from the computing device 105, thereby preferably initiating maintaining, and/or enhancing the operation of the custom design system 100, as will be described in greater detail below. It should be understood that computing devices 115 can be in direct communication with computing device 105, indirect communication with computing device 105, and/or can be communicatively coordinated with computing device 105, as will be described in greater detail below. While computing device 115 can be practically any device capable of communication with computing device 105, in the preferred embodiment computing device 115 is a personal computer, server, handheld/portable computer, smartphone, personal digital assistant (PDA), tablet computer, and/or any other such computing device that is capable of transmitting and/or receiving data to/from computing device 105. It should also be appreciated that in many implementations, computing device 115 will be substantially identical, from a structural and functional perspective, to computing device 105.

It should be noted that while FIG. 1 depicts custom design system 100 with respect to computing devices 115A-N, it should be understood that any number of computing devices can interact with the custom design system 100 in the manner described herein. It should be further understood that a substantial number of the operations described herein are initiated by and/or performed in relation to such computing devices 115. For example, as referenced above, such computing devices 115 can execute applications and/or viewers which request and/or receive data from computing device 105, substantially in the manner described in detail herein.

In certain implementations, one or more external databases and/or servers 182 are also in communication with computing device 105. As will be described in greater detail below, database/server 182 is preferably a computing and/or storage device, and/or a plurality of computing and/or storage devices, that contain(s) application(s) and/or information, such as configuration tool 183, media items 184, complementary items 185, design template 186, addresses 187, and social network profile 188, that can be relevant to customizing a printed bracelet as described in detail herein. Such external databases/servers 182 are in addition to the internal or local database 180 of computing device 105. It should be understood that databases 180 and 182 can, in many cases, contain similar, complimentary, and/or identical information. The primary distinction between database 180 and database 182 is that database 180 is local to computing device 105 (thus not requiring additional communication to access) while database 182 is external and thus requires communication between computing device 105 and database/server 182 in order to access the data stored therein. It should be noted that in certain implementations custom design system 100 can be configured such that various items (such as media items 184) can be stored at one location (such as at database 182), while various other related items (such as complementary items 185) can be stored at a second location (such as at database 180), as will be described in greater detail below.

At this juncture it should be noted that in certain implementations, such as the one depicted in FIG. 1, computing devices 115 and/or database/server 182 can be in periodic or ongoing communication with computing device 105 thorough a computer network such as the Internet 160. Though not shown, it should be understood that in certain other implementations, computing devices 115 and/or database/server 182 can be in periodic or ongoing direct communication with computing device 105, such as through communications interface 150.

Moreover, in certain implementations, one or more printing devices, such as printing device 125 can be connected to and/or in communication with computing device 105, such as through communication interface 150. Printing device 125 can be practically any type of consumer or commercial printer, such as an inkjet or laser printer, though it should be understood that any device capable of producing the custom bracelets referenced herein is to be considered within the scope of the term printing device as used herein. Additionally, it should be understood that in certain implementations the structure and/or functions of printing device 125 and computing device 105 can be incorporated into a single device, such as a printer having document processing capabilities, as are known to those of ordinary skill in the art. It should also be noted that printing device 125 is preferably configured to print the referenced custom bracelets using specially perforated cards 135, as will also be described in greater detail herein.

In the description that follows, certain embodiments and/or arrangements are described with reference to acts and symbolic representations of operations that are performed by one or more devices, such as the custom design system 100 of FIG. 1. As such, it will be understood that such acts and operations, which are at times referred to as being computer-executed or computer-implemented, include the manipulation by processor 110 of electrical signals representing data in a structured form. This manipulation transforms the data and/or maintains them at locations in the memory system of the computer (such as memory 120 and/or storage 190), which reconfigures and/or otherwise alters the operation of the system in a manner understood by those skilled in the art. The data structures in which data are maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the custom design system 100. Other components shown in FIG. 1 can be varied from the illustrative examples shown. The different embodiments can be implemented using any hardware device or system capable of running program code. In another illustrative example, custom design system 100 can take the form of a hardware unit that has circuits that are manufactured or configured for a particular use. This type of hardware can perform operations without needing program code to be loaded into a memory from a computer readable storage device to be configured to perform the operations.

For example, computing device 105 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 130 can be omitted because the processes for the different embodiments are implemented in a hardware unit.

In still another illustrative example, computing device 105 can be implemented using a combination of processors found in computers and hardware units. Processor 110 can have a number of hardware units and a number of processors that are configured to execute software modules 130. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 150 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

It should be further understood that while the various computing devices and machines referenced herein, including but not limited to computing device 105, computing devices 115A-N, printing device 125, and database/server 182 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art.

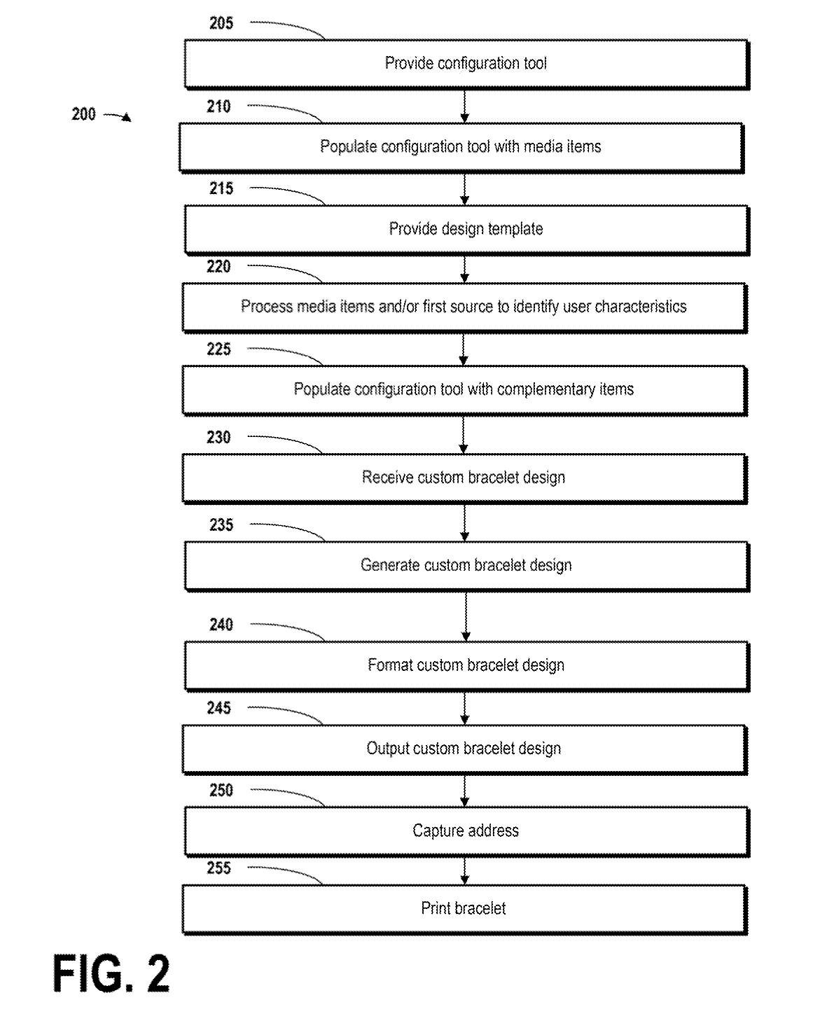

The operation of the custom design system 100 and the various elements and components described above will be further appreciated with reference to the method for recognizing one or more characters within a distorted image as described below, in conjunction with FIGS. 2-5.

Turning now to FIG. 2, a flow diagram is described showing a routine 200 that illustrates a broad aspect of a method for dynamic customization of a printed bracelet in accordance with at least one embodiment disclosed herein. It should be appreciated that several of the logical operations described herein are implemented (1) as a sequence of computer implemented acts or program modules running on custom design system 100 and/or (2) as interconnected machine logic circuits or circuit modules within the custom design system 100. The implementation is a matter of choice dependent on the requirements of the device (e.g., size, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

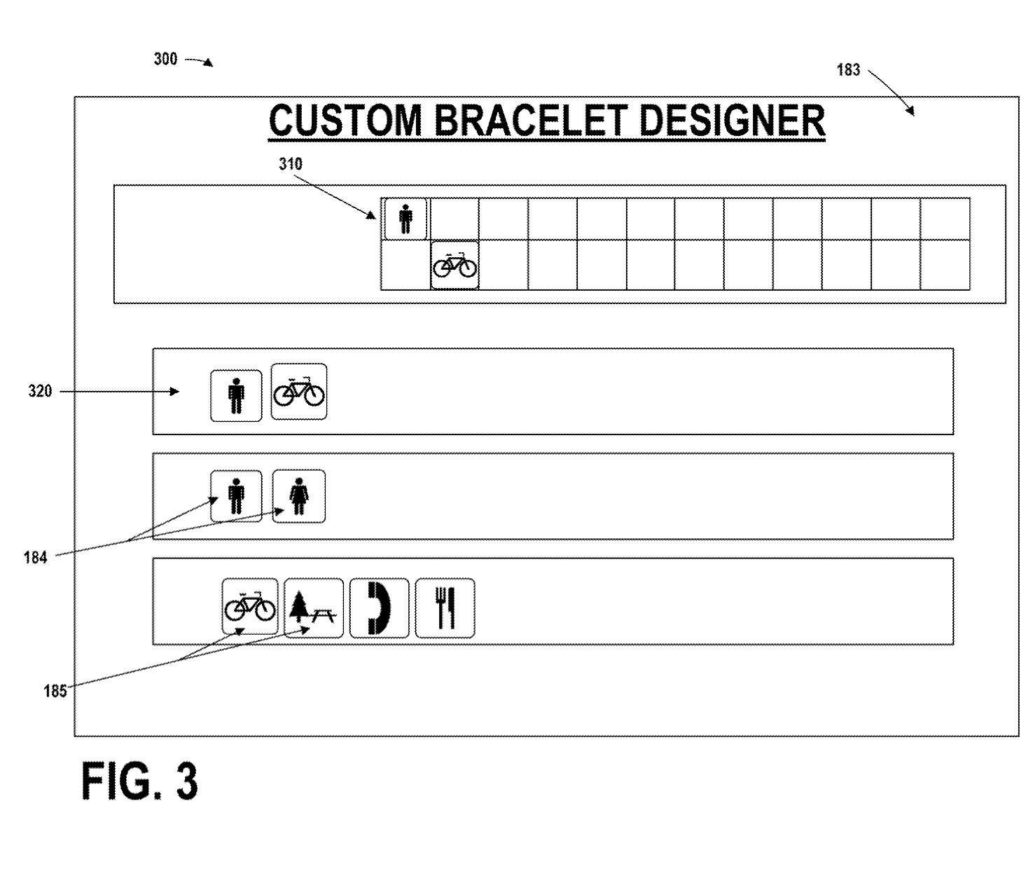

The process begins at step 205 where processor 110 executing one or more of software modules 130, including, preferably, customization application 170, configures computing device 105 to provide a configuration tool 183 at a user interface. Configuration tool 183 is preferably an application or app that can be interacted with at a user device, such as computing device 115. For example, configuration tool 183 can be an Adobe Flash application or service that can be integrated within a social networking website. FIG. 3 depicts an exemplary screenshot 300 of configuration tool 183, such as an Adobe Flash web application that is accessible at a user interface such as a web browser. The configuration tool 183 provides an environment whereby users can design custom bracelets, as will be described in greater detail below.

At step 210, processor 110 executing one or more of software modules 130, including, preferably, customization application 170, configures computing device 105 to populate configuration tool 183 with media items 184 such as digital images or photos. Preferably, the one or more media items 184 are obtained from a first source such as storage device, computing device, and/or website/network location. For example, a user can select to populate configuration tool 183 with media items 184 from sources such as a local computer or device, a remote computer or device (such as a third party photo storage website), and/or a social networking profile that enables users to store and/or post images. Moreover, in certain implementations a user can provide a permission that grants the configuration tool 183 temporary and/or ongoing access to such sources (e.g., a permission that grants the configuration tool 183 permanent access to the media items 184 stored on a social networking profile). For example, FIG. 3 depicts media items 184 obtained from a social networking user profile, such as personal pictures, as populated within configuration tool 183.

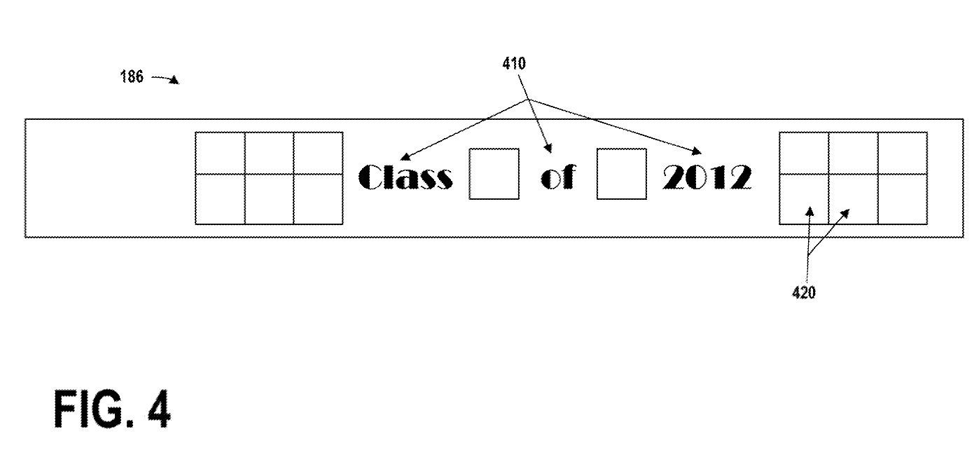

Then, at step 215, processor 110 executing one or more of software modules 130, including, preferably, customization application 170, configures computing device 105 to provide a design template 186 at the user interface. Such design templates 186 preferably reflect a framework within which a bracelet can be designed. For instance, a template can include one or more background images, and can further include one or more predefined locations within which a user can place and/or arrange various items, such as media items 184 and complementary items 185, as will be described herein. By way of illustration, FIG. 4 depicts an exemplary design template 186 which includes a background design 410 (‘Class of 2012’) as well as predefined locations 420 where a user can place/arrange various items. In doing so, various background designs and/or themes can be incorporated into the printed bracelet. For example, a company wishing to promote a new product can create a custom design template 186 as a marketing tool, and allow users to use such a template to create custom bracelets at a reduced cost (or for free).

At step 220, processor 110 executing one or more of software modules 130, including, preferably, customization application 170, configures computing device 105 to process the media items 184 and/or the first source in order to identify one or more user characteristics. That is, it can be appreciated that both media items 184 (e.g., personal photos) and the source of the media items 184 (e.g., a social networking profile 188) can contain various data and content that can provide additional information regarding the interests or preferences of the user. Thus, such media items 184 and sources can be processed (e.g., by processing metadata tags associated with the media items 184, and/or by processing various interests or preferences indicated by the user on a social networking profile, etc., in a manner are known to those or ordinary skill in the art). In doing so, one or more user characteristics regarding the user can be identified. For example, based on the presence of several rock bands in the ‘like’ section of the social networking profile 188 of a particular user, it can be determined that the user enjoys rock music. By way of further example, if a number of the media items 184 contain metadata such as time/date stamps during the month of December, it can be determined that the media items 184 can relate to holidays and/or winter.

At step 225, processor 110 executing one or more of software modules 130, including, preferably, customization application 170, configures computing device 105 to populate configuration tool 183 with one or more complementary items 185. In certain implementations, complementary items 185 can be referred to as “goodies” and are various images or graphics such as symbols, charms, and/or logos. Preferably, complementary items 185 are populated into configuration tool 183 (an example of which is depicted in FIG. 3) based on user characteristics, such as those identified at step 220. For example, having identified (such as at step 220) that a user is a fan of the New York Yankees baseball team (e.g., based on a social networking profile 188 of the user, as described above), one or more related complementary items 185, such as images, icons, and/or graphics, can populated into configuration tool 183, such as baseballs, bats, Yankees logos, etc. It should also be noted that in certain implementations the complementary items 185 preferably originate from a source other than the source of the media items 184. For example, complementary items 185 can be stored at a third-party server.

Then, at step 230, processor 110 executing one or more of software modules 130, including, preferably, customization application 170, configures computing device 105 to receive a custom bracelet design 310 through the configuration tool 183. An exemplary custom bracelet design 310 is shown in FIG. 3. The custom bracelet design 310 is preferably an arrangement of one or more user selections of the various media items 184 and/or the complementary items 185. That is, a user can interact with configuration tool 183 to arrange the various media items 184 and/or complementary items 185, thereby creating a custom bracelet design 310. Moreover, in certain implementations, a user workspace 320 can be included in configuration tool 183. Such a workspace 320 can provide a user with an area within which various media items 184 and complementary items 185 can be stored and/or arranged, prior to the arrangement of such items into custom bracelet design 310.

At step 235, processor 110 executing one or more of software modules 130, including, preferably, customization application 170, configures computing device 105 to generate at a portion of the custom bracelet design 310. That is, in certain scenarios it can be desirable for a user to have the option of having at least a portion of (or the entirety of) a custom bracelet design 310 be generated in an automated fashion, in lieu of the user manually providing selections of media items 184 and/or complementary items 185 using the configuration tool 183. In one implementation, the user can indicate one or more media items 184 and/or complementary items 185 that the user wishes to include in the custom bracelet design 310. For example, the user can populate the workspace 320 with such items. The media items 184 and/or complementary items 185 that the user selects can then be incorporated into a custom bracelet design 310 that is generated (using image arrangement/randomization techniques known to those of ordinary skill in the art) without requiring further input from the user. In an alternative arrangement, the custom bracelet design can be generated (incorporating media items 184 and/or complementary items 185) without any input from the user.

At step 240, processor 110 executing one or more of software modules 130, including, preferably, customization application 170, configures computing device 105 to format the custom bracelet design 310. That is, the custom bracelet design 310 generated at steps 230 and/or 235 can be rendered for printing on a perforated card 135. For example, custom bracelet design 310 can be rendered as a PDF or JPEG file.

At step 245, processor 110 executing one or more of software modules 130, including, preferably, customization application 170, configures computing device 105 to output the custom bracelet design 310 in furtherance of a printing of the printed bracelet. In doing so, the custom bracelet design 310, such as the one rendered at step 240, can be transmitted to another device (such as computing device 115) and/or to printing device 125. By way of example, in one implementations the custom bracelet design 310 can be sent to the user (e.g., as a PDF file attachment to an email message), thereby enabling the user to print the bracelet using a home printing device (such as a consumer printer). By way of further example, the custom bracelet design 310 can be transmitted to a computing device 115 and/or a printing device 125 at a remote location, such as a professional printing company that is responsible for performing the relevant printing operations at such a remote location.

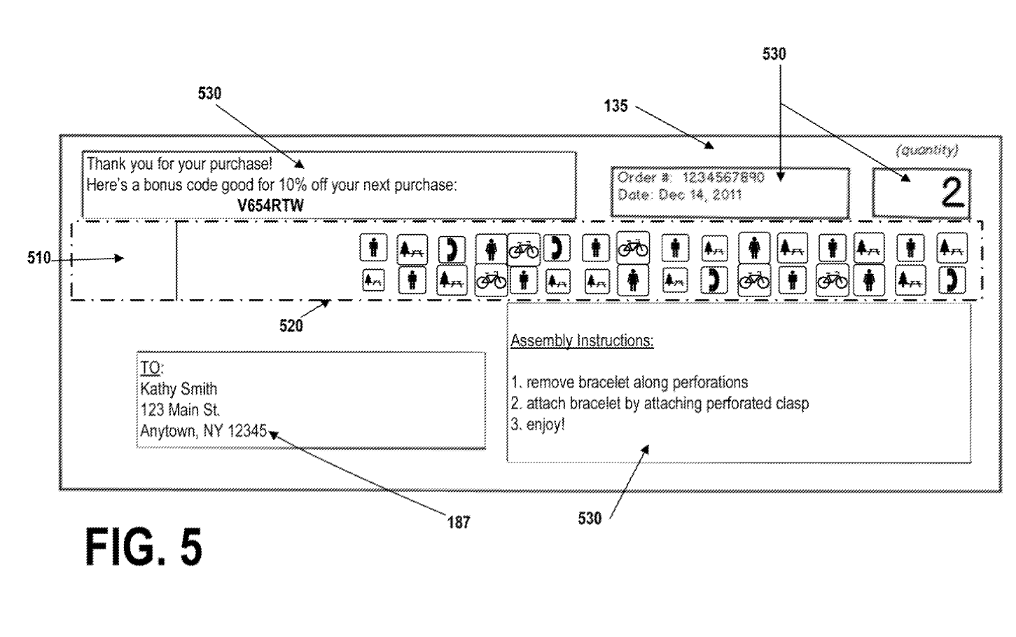

At step 250, processor 110 executing one or more of software modules 130, including, preferably, customization application 170 can configure computing device 105 to capture an address 187 associated with the printed bracelet. That is, one or more addresses 187 can be obtained (such as from databases 180 and/or 182) and incorporated into the custom bracelet design 310 that is preferably rendered to enable the design to be printed on a perforated card 135 that can also serve as a mailer, as will be described in greater detail below. For example, FIG. 5 depicts an exemplary perforated card 135.

At step 255, processor 110 executing one or more of software modules 130, including, preferably, customization application 170, configures computing device 105 to print (such as in an implementation whereby the computing device 105 includes integrated printing components) and/or to activate a printing device 125 to print (such as in an implementation whereby a peripheral printing device is connected and/or in communication with computing device 105) the printed bracelet 510 and the address 187 on a perforated card 135. It should be understood that the perforated card 135 is preferably constructed to function as a mailer and for assembly as the printed bracelet 510. That is, as referenced above, one or more sections or areas are preferably included which enable the card to be addressed and mailed to a particular user. It can be appreciated that by doing so, if done, the printed card 135 can be efficiently printed and mailed to the user. It should also be understood that the term “mailer” as used herein encompasses standalone printed products that can be mailed upon printing, as-is, such as postcards, as well as printed products that are arranged to be mailed within envelopes, including envelopes having an opening or a translucent window that allow an address printed on an item enclosed therein to be viewable through the envelope, as are known to those of ordinary skill in the art (in such implementations, printed card 135 preferably includes at least one area 530 that is oriented to align with such an opening/window, such that an address printed on such an area is viewable even when the perforated card 135 is enclosed within the envelope). Additionally, the card 135 is preferably perforated such that the printed bracelet 510 can be removed from the card 135 (by way of the perforations 520) and assembled as a printed bracelet 510 that reflects the custom bracelet design 310.

It should be noted that in certain implementations, the activation and/or printing referenced herein can be performed based on the custom bracelet design 310. That is, it can be appreciated that various printing devices 125 have different printing capacities and/or capabilities. For example, certain printing devices 125 are more proficient at printing text, while others are more proficient at printing images. Moreover, it can be appreciated that printing devices can be configured for efficiency to be restricted to printing only in or on specific formats or media types, such as envelopes, paper sizes, etc. Accordingly, in certain implementations a particular custom bracelet design 310 can be routed to and/or printed by a printing device 125 that is specifically configured to print bracelets having characteristics in common with custom bracelet design 310. For example, as referenced above, a company can provide a template 186 that can be customized by users. Thus, in such scenarios a printing device 125 can be specifically configured to print custom bracelet designs 310 that are based on such a template 186. It can be further appreciated that in certain implementations perforated card 135 can be pre-printed with background design 410 of template 186, thereby further increasing the printing efficiency of the printed bracelet 510.

It should also be noted that perforated card 135 can include sections or areas 530 that provide space for the printer or service provider to print messages and/or information, such as order number, date, order quantity, promotional codes and/or assembly instructions. It should also be noted that while perforated card 135 is preferably a cardboard card suitable for printing, in other implementations perforated card 135 can be practically any material or substance, such as plastic.

It can be appreciated that a practically unlimited number of additional examples, scenarios, and applications exist that can benefit from the custom design systems and methods described herein. An example of such further applications includes printed greeting cards. It should also be understood that such further applications are within the scope of the methods and systems described herein.

It is to be understood that like numerals in the drawings represent like elements through the several figures, and that not all components and/or steps described and illustrated with reference to the figures are required for all embodiments or arrangements. It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein. It should be appreciated that according to at least one embodiment, one or more computer programs, modules, and/or applications that when executed perform methods of the present invention need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for dynamically customizing a printed bracelet. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A computer-implemented method for dynamic customization of a printed bracelet using a computing device, the method comprising:
providing a configuration tool at a user interface;
populating the configuration tool with one or more media items, the one or more media items being obtained from a first source via a permission from a user;
processing, with a processor executing code, at least one of (i) the one or more media items and (ii) the first source in order to identify one or more user characteristics;
based on the one or more user characteristics, further populating the configuration tool with one or more complementary items, the one or more complementary items originating from at least a second source;
receiving, through the configuration tool, a custom bracelet design, the custom bracelet design comprising an arrangement of one or more selections of at least one of the one or more media items and the one or more complementary items; and
outputting the custom bracelet design in furtherance of a printing of the printed bracelet.

2. The method of claim 1, wherein the first source is a social networking profile associated with a social networking website.

3. The method of claim 1, wherein the first source is a folder associated with a machine at which the user interface is provided.

4. The method of claim 1, further comprising formatting the custom bracelet design for printing on a perforated card.

5. The method of claim 4, wherein the perforated card is constructed for assembly as the printed bracelet.

6. The method of claim 1, further comprising generating at least a portion of the custom bracelet design.

7. The method of claim 1, wherein the configuration tool is an application configured for integration within a social networking website.

8. The method of claim 1, wherein the one or more media items comprise one or more digital images.

9. The method of claim 1, wherein the one or more user characteristics comprise at least one of: a user interest, a user association, and a theme identified among the one or more media items.

10. The method of claim 1, wherein the one or more complementary items comprise one or more digital images.

11. The method of claim 1, further comprising capturing an address associated with the printed bracelet.

12. The method of claim 11, further comprising printing the printed bracelet and the address on a perforated card, the perforated card being constructed (i) as a mailer and (ii) for assembly as the printed bracelet.

13. The method of claim 1, wherein the one or more selections modify at least one of (a) the one or more media items populating the configuration tool and (b) the one or more complimentary items populating the configuration tool.

14. The method of claim 1, further comprising providing a design template at the user interface, the design template comprising a framework within which the one or more selections of the at least one of the one or more media items and the one or more complementary items can be arranged.

15. The method of claim 14, wherein the template further comprises one or more predefined locations within which the one or more selections of the at least one of the one or more media items and the one or more complementary items can be arranged.

16. The method of claim 1, wherein the first source is a media repository.

17. A computer-implemented method for dynamic customization of a printed bracelet using a computing device, the method comprising:
providing a configuration tool at a user interface;
populating the configuration tool with one or more complementary items;
receiving, through the configuration tool, a custom bracelet design, the custom bracelet design comprising an arrangement of one or more selections of at least one of the one or more complementary items; and
outputting the custom bracelet design in furtherance of a printing of the printed bracelet.

18. The method of claim 17, further comprising populating the configuration tool with one or more media items.

19. The method of claim 18, wherein the custom bracelet design comprises an arrangement of one or more selections of at least one of the one or more complementary items and the one or more media items.

20. A system configured to generate a printed bracelet, the system comprising a computing device and a printing device in communication with the computing device, the computing device having one or more processors configured to interact with a computer-readable medium in order to perform operations comprising:
providing a configuration tool at a user interface;
populating the configuration tool with one or more media items, the one or more media items being obtained from a first source via a permission from a user;
processing at least one of (i) the one or more media items and (ii) the first source in order to identify one or more user characteristics;
based on the one or more user characteristics, further populating the configuration tool with one or more complementary items, the one or more complementary items originating from at least a second source;
receiving, through the configuration tool, a custom bracelet design, the custom bracelet design comprising an arrangement of one or more selections of at least one of the one or more media items and the one or more complementary items;
capturing an address associated with the printed bracelet; and
based on the a custom bracelet design, activating the printing device to print the printed bracelet and the address on a perforated card, the perforated card being constructed (i) as a mailer and (ii) for assembly as the printed bracelet.
